(19) United States
(12) Patent Application Publication
(10) Pub. No.: US 2014/0044980 A1
(43) Pub. Date: Feb. 13, 2014

(54) MULTILAYERED TWO-DIMENSIONAL OR TUBULAR FOOD CASING OR FOOD FILM

(71) Applicant: Kuhne Anlagenblau GmbH, St. Augustin/Menden (DE)

(72) Inventor: Jurgen Schiffmann, Hennef-Rott (DE)

(73) Assignee: Kuhne Anlagenblau GmbH, St. Augustin/Menden (DE)

(21) Appl. No.: 14/060,383

(22) Filed: Oct. 22, 2013

Related U.S. Application Data
(63) Continuation of application No. 12/311,374, filed on Mar. 27, 2009, now abandoned.

(30) Foreign Application Priority Data
Sep. 29, 2006 (DE) 10 2006 046 4873.

(51) Int. Cl. B32B 27/08; B32B 27/32; B32B 27/36

(52) U.S. Cl. CPC B32B 27/08; B32B 27/36; B32B 27/32
USPC 428/474.4; 428/480; 428/483; 220/660

(57) ABSTRACT

The present invention proposes for the first time a two-dimensional or tubular food casing or film with an at least seven-layered laminated structure, which has an EVOH layer as an oxygen barrier and in which the outer layer is formed by a high-temperature-resistant material such as PET, which apart from outstanding appearance-related properties also makes much higher further processing speeds (numbers of cycles) possible than previously known.

### CROSS-REFERENCE TO RELATED APPLICATIONS

This continuation patent application is entitled to and hereby claims the benefit of priority, under 35 U.S.C. §§120 and 121, of the filing date of commonly owned U.S. National Stage patent application Ser. No. 12/311,374 filed on Mar. 27, 2009, entitled “MULTILAYERED TWO-DIMENSIONAL OR TUBULAR FOOD CASING OR FOOD FILM”;” which in turn claims the benefit of priority of the filing date of commonly owned International application PCT/EP2007/006025, having a PCT publication number WO 2008/040404, filed Apr. 10, 2008, which claims priority to German Application No. 10 2006 046 4873.4, filed on Sep. 29, 2006, the entire contents of all of which are incorporated herein by reference.

The present invention relates to a multilayered two-dimensional or tubular food casing or food film which is produced by the nozzle blast-drawing process and biaxially oriented by the triple-bubble process, for food packagings such as, e.g., shrink bags, sealable films, wrapping films or the like, in accordance with the preamble of claim 1.

In practice, such multilayered tubular or two-dimensional packaging films are already being utilized in the form of 5- or 7-layered films.

Thus, e.g., EP 0 236 099 B2 discloses a multilayered tubular packaging film for foodstuffs—referred to as a packaging oxygen barrier film—having up to 7 layers. It is a drawback in the disclosed film, however, that the external layer is comprised of a polyolefin (in brief: PO) which does provide good protection against humidity for the inner layers but does not have a clearly enhanced temperature resistance in comparison with the inner layer (seal layer).

EP 0 476 836 B1 discusses a 6-layer packaging film which in contrast with EP 0 236 099 B2 contains a temperature-resistant external layer of PET, however the core layers comprised of EVOH and PA for oxygen barrier and mechanical strength are not protected against humidity by a separate, pure PO layer, for neither PET nor the adhesion promoter (in the following briefly referred to as AP) satisfy these demands to the water vapor barrier.

Moreover the lack of an external PO layer results in a very high tendency of curling to the outside.

EP 1 034 076 B1 also discusses a packaging film, referred to as a heat-shrinkable thermoplastic multilayered film, having a temperature-resistant external layer comprised of PA. This is, however, merely a 5-laminated structure which moreover also does not have any PO layer as a water vapor barrier from the outside. This in turn results in a particularly high curling tendency, accompanied by a highly impaired water vapor barrier as well as highly impaired strength, for both the EVOH and the PA are exposed to humidity without any protection.

PCT/EP2004/051560, published as WO 2005/011978 A1, furthermore discloses a 5-layer packaging film having a temperature-resistant external layer of PET and a core layer of EVOH for a barrier. But here, too, no humidity barrier from the outside is provided. In addition, the manufacturing process discussed in PCT/EP2004/051560 is an entirely different manufacturing process. The films disclosed in PCT/EP2004/051560 are manufactured not by the blown film process with biaxial orientation (triple-bubble process) but by the flat tape process with biaxial orientation (tender-frame process).

Accordingly it is an object of the present invention to further develop a generic multilayered two-dimensional or tubular food casing or food film in such a way that a sufficiently tight oxygen barrier may be provided with a concurrently high water vapor barrier and with excellent mechanical strength, excellent optical properties, good suitability for further processing, high temperature resistance of the external layer, and a satisfactory shrinkage rate, while avoiding the above-discussed drawbacks.

This object and these aspects are attained through the features of claim 1.

In accordance with the invention, a multilayered two-dimensional or tubular food casing or food film which is in particular produced by the nozzle blast-drawing process and biaxially oriented by the triple-bubble process, for food packagings such as, e.g., shrink films, sealable films, wrapping films or the like, is being proposed which is for the first time characterized by the following laminated structure including at least seven layers that are counted from the outside to the inside.

The first layer from the outside contains PET as a layer component, the second layer an adhesion promoter, the third layer an ionomer, the fourth layer an adhesion promoter, the fifth layer an EVOH, the sixth layer an adhesion promoter, and the seventh layer from the outside, which at the same time is the innermost layer, a polyolefin, preferably polyethylene.

The EVOH advantageously forms the desired oxygen barrier. The ionomer allows to ensure the desired mechanical properties. The polyester allows to ensure excellent optical properties, such as gloss and transparency, and to obtain a high speed of further processing (cycle numbers) thanks to the high temperature resistance.

The PO furthermore allows to obtain the required water vapor barrier, and it is possible to positively influence the sealing capability of the inner layer, i.e., a high sealing bond strength may be achieved at a lowest possible sealing temperature.

The polyolefins advantageously include both PE and EVA and EM(M)A within the meaning of the present application, as well as blends of polyolefins as such and also with ionomers.

Furthermore, EVA designates both EVA and blends of EVA with polymers, ionomers, or EM(M)A. The adhesion promoters (in brief: AP) represent an adhesive layer. EVOH is to be understood both as EVOH and blends of EVOH with other polymers.

Advantageously a food casing or food film for food packagings is thus being furnished which alternatively allows to obtain a defined high shrinkage of up to 60% or, in contrast, a defined low shrinkage as low as 0%.

By means of the layered structures thus proposed for the first time it is advantageously possible to achieve a particularly high shrinkage for shrink bags etc., amounting to at least 30% to 70%, preferably at least 40% to 60%, measured at a water temperature of about 90° C.

By means of the layered structures thus proposed for the first time it is advantageously possible to achieve a particularly low shrinkage for sealable films etc., amounting to 0-30% at the most, preferably 2-5%, measured at a water temperature of about 90° C.

With the laminated structures thus proposed for the first time it is advantageously possible to provide, for example, a polyolefin, preferably with LDPE, LLDPE, EVA, EM(M)A, ionomers or POP or blends thereof etc., as a starting material for the seal layers that are to be provided on the inside of shrink bags or sealable films, respectively.

The particularly pronounced oxygen barrier obtained as a result of the layer component EVOH ensures excellent preservation over several weeks without any quality decrease of the foods thereby packaged.

Thanks to the extremely well-formed oxygen barrier, the food casing or food film of the invention for the first time moreover furnishes a food packaging whereby even goods that are particularly sensitive to air are not subject to color changes or even to the risk of ageing or changing their taste or aroma due to the entry of oxygen, even over long storage periods.

As the barrier properties of EVOH may be influenced negatively by humidity, a sandwich-type laminated structure, i.e., embedding of the EVOH between two polyolefin layers as a water vapor barrier from the inside and from the outside, is preferred.

Hereby an excellent water vapor barrier may be made available, which is crucial particularly in the case of meats or other foods that need to be kept fresh. Foodstuffs packaged with the food casing or food film of the invention thus stay fresh for a particularly long time.

Owing to the low water vapor permeability, the weight losses involved in storing the foods and particularly in storing meats remain particularly low.

The outermost layer of the food casing or food film thus proposed for the first time moreover consists of high-temperature-resistant starting materials such as PET and therefore admits the possibility of welding the films by extremely high temperatures without the film being bonded to the welder terminal. As a result, higher cycle numbers may be achieved on the welding machines. In addition the film is substantially less sensitive to external injury and possesses—as is customary for PET—excellent optical properties in regard of gloss and transparency. Furthermore the film is particularly well suited for inscribing or printing.

In addition, the food casing or food film of the invention may be manufactured and processed particularly well with the aid of corresponding facilities by the same applicant.

Advantageous aspects or developments of the invention result from the features of the appended claims.

Thus, in a preferred embodiment of the food casing or food film for food packagings in accordance with the invention it is provided that layers which contain polyethylene as a layer component alternatively also contain polypropylene, EVA (Ethyl Vinyl Alcohol), EM(M)A, ionomers, or blends of these, or the like.

In a preferred embodiment it is moreover provided that layers which contain an adhesion promoter include an adhesion promoter on the basis of PE, EVA, EM(M)A or of an ionomer as a base material.

In accordance with a further preferred embodiment it is provided that layers which include an adhesion promoter as a component alternatively contain a blend of polyolefin and adhesion promoter or a blend of EVA and/or EM(M)A and adhesion promoter.

In accordance with a further preferred embodiment it is provided that layers which include EVOH as a layer component alternatively contain MXD6 (modified polyamide).

In a further preferred embodiment it is provided that layers which include EVOH as a component alternatively contain PVA.

In accordance with a further preferred embodiment it is provided that layers which contain EVOH, PVA or MXD6 alternatively contain blends of these starting materials with PA.

In accordance with a further preferred embodiment it is provided that layers which include PET as a layer component alternatively contain polycaprolactame (PA6), polyhexamethylene adipinamide (PA66), PA6/66, PA11, PA12, or blends of these polyamides or the like.

An equally further preferred embodiment provides that the external layer which contains PET as a layer component alternatively includes PA, PS or PC.

In addition, further preferred embodiments provide that the external layer which contains PET alternatively includes COC, PP, or HDPE or blends of these starting materials with polyolefin, respectively.

Further preferred embodiments finally provide that the two-dimensional or tubular food casing or food film is fashioned as a food packaging having the form of a shrink bag or a sealable film.

The present invention thus for the first time proposes a two-dimensional or tubular food casing or food film having a laminated structure with at least seven layers, which possesses an EVOH layer for an oxygen barrier, and wherein the external layer is formed by a high-temperature-resistant material such as PET which on top of its excellent optical properties also enables clearly higher speeds for further processing (cycle numbers).

1. A multilayered two-dimensional or tubular food casing or food film which is produced by the nozzle blast-drawing process and biaxially oriented by the triple-bubble process, characterized by the following laminated structure including at least seven layers that are counted from the outside to the inside, wherein:
a first layer from the outside comprises PET as a layer component,
a second layer from the outside comprises an adhesion promoter as a layer component,
a third layer from the outside comprises an ionomer as a layer component,
a fourth layer from the outside comprises an adhesion promoter as a layer component,
a fifth layer from the outside comprises EVOH as a layer component,
a sixth layer from the outside comprises an adhesion promoter as a layer component,
a seventh layer from the outside comprises a polyolefin as a layer component.

2. The multilayered two-dimensional or tubular food casing or food film according to claim 1, wherein any layers which comprise a polyolefin, as a layer component comprise a blend of polyolefins.

3. The multilayered two-dimensional or tubular food casing or food film according to claim 1 wherein any layers which contain an adhesion promoter include an adhesion promoter on the basis of PE, PP, EVA, EMMA and/or an ionomer as a base material.

4. The multilayered two-dimensional or tubular food casing or food film according to claim 1, wherein any layers which include an adhesion promoter comprise a blend of polyolefin and adhesion promoter, a blend of EVA, EMMA, and/or EMA and adhesion promoter, an ionomer and the adhesion promoter, and/or various adhesion promoters or blends thereof, respectively, in the single layers.

5. The multilayered two-dimensional or tubular food casing or food film according to claim 1, wherein the fifth layer from the outside further comprises MXD6 (modified polyimide 6).

6. The multilayered two-dimensional or tubular food casing or food film according to claim 1, wherein the fifth layer from the outside further comprises polyvinyl alcohol.

7. The multilayered two-dimensional or tubular food casing or food film according to claim 1, wherein the fifth layer from the outside further comprises a blend EVOH, polyvinyl alcohol, and/or MXD6 with PA.

8. The multilayered two-dimensional or tubular food casing or food film according to claim 1, wherein the first layer from the outside further comprises polycaprolactame (PA6), polyhexamethylene adipinamide (PA66), PA6/66, PA11, and/or PA12.

9. The multilayered two-dimensional or tubular food casing or food film according to claim 1, wherein the first layer from the outside further comprises (polystyrene) a polystyrene.

10. The multilayered two-dimensional or tubular food casing or food film according to claim 1, wherein the first layer from the outside further comprises COC.

11. The multilayered two-dimensional or tubular food casing or food film according to claim 1, wherein the first layer from the outside further comprises a polyolefin.

12. The multilayered two-dimensional or tubular food casing or food film according to claim 1, wherein the first layer from the outside further comprises a polycarbonate.

13. The multilayered two-dimensional or tubular food casing or food film according to claim 1, wherein the food casing or food film is fashioned as a food packaging having the form of a shrink bag or a sealable film.

14. The multilayered two-dimensional or tubular food casing or food film according to claim 1, wherein the seventh layer from the outside comprises polyethylene as a layer component.

15. The multilayered two-dimensional or tubular food casing or food film according to claim 11, wherein the polyolefin comprises PP, HDPE, and/or blends of these.

16. The multilayered two-dimensional or tubular food casing or food film according to claim 1, wherein in any layers which comprise a polyolefin as a layer component, the polyolefin is selected from polyethylene, polypropylene, EVA, EMA, EMMA or blends of these.

17. The multilayered two-dimensional or tubular food casing or food film according to claim 21, wherein in any layers which comprise a polyolefin comprise a blend of polyolefin with ionomers.

18. The multilayered two-dimensional or tubular food casing or food film according to claim 1, wherein the EVOH-containing fifth layer is embedded between two polyolefin layers as a water vapor barrier from the inside and the outside.
